(19) United States
(12) Patent Application Publication
(10) Pub. No.: US 2013/0024127 A1
(43) Pub. Date: Jan. 24, 2013

(54) DETERMINATION OF SOURCE CONTRIBUTIONS USING BINOMIAL PROBABILITY CALCULATIONS

(71) Applicants: John Stuelpnagel, San Jose, CA (US); Craig Struble, San Jose, CA (US)

(72) Inventors: John Stuelpnagel, San Jose, CA (US); Craig Struble, San Jose, CA (US)

(21) Appl. No.: 13/553,012

(22) Filed: Jul. 19, 2012

Related U.S. Application Data
(60) Provisional application No. 61/509,188, filed on Jul. 19, 2011.

(51) Int. Cl. G06F 19/10

(52) U.S. Cl. 702/19

(57) ABSTRACT

This invention relates to calculation of percent contribution of data from a major source and a minor source in a sample.

### CROSS-REFERENCE TO RELATED APPLICATIONS

This application claims the benefit of provisional Patent Application Ser. No. 61/509,188, filed Jul. 19, 2011 as assigned to the Assignee of the present application and incorporated herein by reference.

### FIELD OF THE INVENTION

This invention relates to processes using binomials for providing best fit probabilities for data sets.

### BACKGROUND OF THE INVENTION

In the following discussion certain articles and processes will be described for background and introductory purposes. Nothing contained herein is to be construed as an “admission” of prior art. Applicant expressly reserves the right to demonstrate, where appropriate, that the articles and processes referenced herein do not constitute prior art under the applicable statutory provisions.

Recent advances in diagnostics have focused on less invasive mechanisms for determining disease risk, presence and prognosis. Diagnostic processes for determining genetic anomalies have become standard techniques for identifying specific diseases and disorders, as well as providing valuable information on disease source and treatment options.

The identification of cell free nucleic acids in biological samples such as blood and plasma allow less invasive techniques such as blood extraction to be used in obtaining nucleic acid samples to be examined for making clinical decisions. For example, cell free DNA from malignant solid tumors has been found in the peripheral blood of cancer patients; individuals who have undergone transplantation have cell free DNA from the transplanted organ present in their bloodstream; and cell free fetal DNA and RNA have been found in the blood and plasma of pregnant women. In addition, detection of nucleic acids from infectious organisms, such as detection of viral load or genetic identification of specific strains of a viral or bacterial pathogen, provides important diagnostic and prognostic indicators. Cell free nucleic acids from a source separate from the patient's own normal cells can thus provide important medical information, e.g., about treatment options, diagnosis, prognosis and the like.

The sensitivity of such testing is often dependent upon the identification of the amount of nucleic acid from the different sources, and in particular identification of a low level of nucleic acid from one source in the background of a higher level of nucleic acids from a second source. Detecting the contribution of the minor nucleic acid species to the total cell free nucleic acids present in the biological sample can provide accurate statistical interpretation of the resulting data.

There is thus a need for processes for determining the estimated contribution of nucleic acids from two or more sources in a biological sample.

### SUMMARY OF THE INVENTION

This Summary is provided to introduce a selection of concepts in a simplified form that are further described below in the Detailed Description. This Summary is not intended to identify key or essential features of the claimed subject matter, nor is it intended to be used to limit the scope of the claimed subject matter. Other features, details, utilities, and advantages of the claimed subject matter will be apparent from the following written Detailed Description including those aspects illustrated in the accompanying drawings and defined in the appended claims.

The present invention relates to processes for calculating the percent contribution of data from a major source and a minor source in a sample. The processes of the invention utilize binomial probability distributions to determine the percentage of nucleic acids from the different sources in a mixed sample. The processes and systems of the invention utilize informative loci with distinguishing regions that allow differentiation of nucleic acids from the different sources.

In one aspect, the invention provides processes for estimating relative quantities of cell free nucleic acids in a mixed sample from an individual, the sample comprising cell free nucleic acids from both normal and putative genetically atypical cells. Such samples include, but are not limited to, samples comprising maternal and fetal cell free nucleic acids and samples that contain cell free nucleic acids from normal cells and cancerous cells.

In another aspect, the invention provides processes for estimating relative quantities of cell free nucleic acids in mixed samples comprising cell free nucleic acids from two or more different organisms in a sample from a single individual, e.g., mammalian nucleic acids from the host and nucleic acids from an infectious organism (e.g., bacterial, fungal or viral nucleic acids).

In yet another aspect, the invention provides processes for estimating relative quantities of cell free nucleic acids in mixed samples comprising cell free nucleic acids from a donor cell source and a host recipient cell source, e.g., cells from a transplant recipient and donor cells from the transplanted organ.

In a first implementation, the invention provides a process for estimating the contribution of cell free nucleic acids from a minor and/or major source in a mixed sample using frequency data derived from distinguishing regions of two or more informative loci in the sample. The data sets provided by measurement of the distinguishing regions are used in the processes of the invention to derive an estimate of contribution from the nucleic acid sources using a binomial distribution calculation.

In a specific aspect, the process includes determining the nucleotide sequence of one or more distinguishing regions of informative loci copies present in a mixed sample. The copies of loci can be measured by “counts”, i.e., the numbers of the particular alleles of the informative loci identified in the mixed sample. The binomial distribution calculation is carried out using the counts of the alleles of the informative loci from the major source and the minor source in a mixed sample. An estimate of the contribution of the minor source nucleic acids and/or the major source nucleic acids can thus be calculated based on these data sets. The counts can be based on raw data, or the counts may be normalized to take into account experimental variation.

In another specific aspect, the mixed sample is a maternal sample comprising maternal and fetal cell free nucleic acids. Thus, the invention provides a process for utilizing data sets of counts for one or more distinguishing regions of two or more informative loci to derive an estimate of fetal enrichment of a maternal sample using a binomial distribution. Preferably, the maternal and fetal cell free nucleic acids are cell free DNA (“cfDNA”).

Thus, in one implementation, the invention provides a computer-implemented process for estimating the contribution of cell free nucleic acids from a major source and/or a minor source in a mixed sample, the process comprising: accessing by the software component a first data set comprising frequency data for two or more informative loci from a major source; accessing by the software component a second data set comprising frequency data for two or more informative loci from a minor source; and calculating an estimated contribution of cell free nucleic acids from the major source and/or the minor source based on a binomial distribution of distinguishing regions from first and second data sets.

In a preferred implementation of the process and the systems of the invention, the calculation is performed using an algorithm that calculates a binomial probability distribution based on the frequency data from the first and second data sets. The contribution of the major source and/or the minor source in a mixed sample can be estimated by calculating the maximum likelihood estimate based on the frequency of the informative loci from the major source and the minor source. In a more specific implementation, the maximum likelihood estimate is modeled by the equation:

$$Binomial ( A , B , p ) = \frac{( A + B ) !}{A ! B !} {{p}^{A} ( 1 - p )}^{B}$$

wherein A is the quantity of copies of an informative locus from the minor source, B is the quantity of copies of an informative locus from the major source, and p is the maximum likelihood estimate for the binomial distribution with quantities A and B.

The probability p corresponding to the maximum likelihood estimate is calculated within a machine environment using an optimization algorithm. Examples of optimization algorithms include, but are not limited to, gradient descent, simulated annealing, and evolutionary algorithms.

In another implementation the invention provides a computer-implemented process for calculating the contribution of cell free nucleic acids from a minor and/or major source in a mixed sample, the process comprising: accessing by the software component a first data set comprising frequency data based on identification of distinguishing regions of two or more major source informative loci in the sample; accessing by the software component a second data set comprising frequency data based on identification of distinguishing regions of two or more minor source informative loci in the sample; and calculating an estimated contribution of cell free nucleic acids from the major source and/or the minor source based on a binomial distribution of the counts of distinguishing regions from first and second data sets.

In a more specific implementation, the invention provides a computer-implemented process for calculating the contribution of cell free nucleic acids from a maternal major source and a fetal minor source in a maternal sample, the system comprising: accessing by the software component a first data set comprising frequency data based on identification of distinguishing regions from copies of two or more informative loci from the maternal major source; accessing by the software component a second data set comprising frequency data based on identification of distinguishing regions from copies of two or more informative loci from the fetal minor source; and calculating an estimated contribution of cell free nucleic acids from the maternal source and/or the fetal source based on a binomial distribution of the counts of the distinguishing regions from first and second data sets.

In another implementation, the invention provides an executable software product stored on a computer-readable medium containing program instructions for estimating nucleic acid contribution in a mixed sample, the program comprising instructions for: inputting a first data set comprising frequency data based on identification of distinguishing regions from copies of two or more informative loci from the major source; inputting a second data set comprising frequency data based on identification of distinguishing regions from copies of two or more informative loci from the minor source; and calculating a percent contribution of cell free nucleic acids from the major source and/or minor source based on a binomial distribution of the first and second data sets.

In yet another implementation, the invention provides a system comprising: a memory; a processor coupled to the memory; and a software component executed by the processor that is configured to receive a first data set comprising the frequency data for at least one distinguishing region from two or more informative loci from a major source; receive a second data set comprising the frequency data for at least one distinguishing region from two or more informative loci from a minor source; and calculate the percent contribution of cell free nucleic acids from the major source and/or minor source based on a binomial distribution of the first and second data sets.

In a specific aspect the invention provides a computer software product including a non-transitory computer-readable storage medium having fixed therein a sequence of instructions which when executed by a computer direct performance of steps of: creating a first data set representing the quantity of informative loci from a minor source in a mixed sample; creating a second data set representing the quantity of informative loci from a major source in the mixed sample; and calculating a percent contribution of cell free nucleic acids from the major source and/or the minor source based on a binomial distribution of distinguishing regions from first and second data sets.

In one embodiment, the calculation of percent contribution of cell free nucleic acids from the major and/or minor source can be optimized through summing the measured counts of multiple informative loci.

These and other implementations, aspects, features and advantages will be provided in more detail as described herein.

### DESCRIPTION OF THE FIGURES

FIG. 1 is a block diagram illustrating an exemplary system environment.

### DETAILED DESCRIPTION

The exemplary embodiments set forth herein relate to estimating the contribution of cell free nucleic acids from a major source and/or a minor source in a mixed sample. The following description is presented to enable one of ordinary skill in the art to make and use the invention and is provided in the context of a patent application and its requirements. Various modifications to the exemplary embodiments and the generic principles and features described herein will be readily apparent. The exemplary embodiments are mainly described in terms of particular processes and systems provided in particular implementations. However, the processes and systems will operate effectively in other implementations. Phrases such as “exemplary embodiment”, “one embodiment” and “another embodiment” may refer to the same or different embodiments. The embodiments will be described with respect to systems and/or devices having certain components. However, the systems and/or devices may include more or less components than those shown, and variations in the arrangement and type of the components may be made without departing from the scope of the invention.

The exemplary embodiments will also be described in the context of particular processes having certain steps. However, the process and system operate effectively for other processes having different and/or additional steps and steps in different orders that are not inconsistent with the exemplary embodiments. Thus, the present invention is not intended to be limited to the embodiments shown, but is to be accorded the widest scope consistent with the principles and features described herein and as limited only by appended claims.

It should be noted that as used herein and in the appended claims, the singular forms “a,” “and,” and “the” include plural referents unless the context clearly dictates otherwise. Thus, for example, reference to “an informative locus” refers to one, more than one, or combinations of such loci, and reference to “a system” includes reference to equivalent steps and processes known to those skilled in the art, and so forth.

Unless expressly stated, the terms used herein are intended to have the plain and ordinary meaning as understood by those of ordinary skill in the art. The following definitions are intended to aid the reader in understanding the present invention, but are not intended to vary or otherwise limit the meaning of such terms unless specifically indicated. All publications mentioned herein are incorporated by reference for the purpose of describing and disclosing the formulations and processes that are described in the publication and which might be used in connection with the presently described invention.

### Definitions

The terms used herein are intended to have the plain and ordinary meaning as understood by those of ordinary skill in the art. The following definitions are intended to aid the reader in understanding the present invention, but are not intended to vary or otherwise limit the meaning of such terms unless specifically indicated.

The term “distinguishing region” refers to a region that is measurably different between loci. Such differences include, but are not limited to, single nucleotide polymorphisms (SNPs), differences in methylation status, mutations including point mutations and indels, short tandem repeats, copy number variants, and the like.

The term “informative locus” as used herein refers to a locus with one or more distinguishing regions which is homozygous in one source and heterozygous in the other source within a mixed sample.

The terms “locus” and “loci” as used herein refer to a nucleic acid region of known location in a genome.

The term “maternal sample” as used herein refers to any sample taken from a pregnant mammal which comprises a maternal major source and a fetal minor source of cell free nucleic acids (e.g., RNA or DNA).

The term “mixed sample” as used herein refers to any sample comprising cell free nucleic acids (e.g., DNA) from two or more sources in a single individual which can be distinguished based on informative loci. Exemplary mixed samples include a maternal sample (e.g., maternal blood, serum or plasma comprising both maternal and fetal DNA), or a peripherally-derived somatic sample (e.g., blood, serum or plasma comprising different cell types, e.g., hematopoietic cells, mesenchymal cells, and circulating cells from other organ systems). Mixed samples include samples with genomic material from two different sources, which may be sources from a single individual, e.g., normal and atypical somatic cells; cells that are from two different individuals, e.g., a sample with both maternal and fetal genomic material or a sample from a transplant patient that comprises cells from both the donor and recipient; or samples with nucleic acids from two or more sources from different organisms, e.g., the mammalian host and an infectious organism such as a virus, bacteria, fungus, parasite, etc.

As used herein “nucleotide” refers to a base-sugar-phosphate combination which are monomeric units of a nucleic acid sequence (DNA and RNA). A nucleotide sequence refers to identification of the particular base for the nucleotide.

The terms “sequencing”, “sequence determination” and the like as used herein refers generally to any and all biochemical processes that may be used to determine the order of nucleotide bases in a nucleic acid.

### The Invention in General

This invention relates to computer-implemented processes for calculating a percent contribution of cell free nucleic acids from a major source and a minor source in a mixed sample. The processes of the invention utilize binomial probability distributions to determine the percentage of nucleic acids from the different sources in a mixed sample. The processes and systems of the invention utilize informative loci with distinguishing regions that allow differentiation of nucleic acids from the different sources.

For example, percent contribution of cell free DNA in a sample from a single individual can be determined by sequencing copies of two or more informative loci present in a mixed sample. For each informative locus, counts for both alleles (signified herein as A and B) present in the mixed sample are determined. With an observation of counts A≦B, A is the count for the less abundant allele of the informative locus (corresponding to the minor source DNA) and B is the count for the more abundant allele (corresponding to the major source DNA).

Statistically, this environment is modeled by a binomial distribution with some probability p of sequencing the A allele in a mixture of A and B alleles:

$$Binomial ( A , B , p ) = \frac{( A + B ) !}{A ! B !} {{p}^{A} ( 1 - p )}^{B} .$$

Since A and B are known, the probability p is the informative value. The value p* of p that maximizes the value of Binomial(A, B, p) is considered the maximum likelihood estimate for the binomial distribution with counts A and B.

For example, since fetal DNA is expected to be less prevalent in maternal plasma, the probability p of sequencing the A allele corresponds to a measure of fetal enrichment f using the following formula:

f=2*p.

The best (most likely) estimate of fetal enrichment given the A and B counts is when p=p*.

A more accurate calculation of the percent contribution of cfDNA from a mixed sample can be calculated using sequence determination of several informative loci within the mixed sample. The use of multiple loci in determining minor source percent DNA contribution increases the likelihood that the percentage is truly representative, as measurement of levels of a single informative locus may not be truly indicative of the level of all minor source DNA.

In order to determine the percentage of a cfDNA from a major source and/or a minor source within a mixed sample, the sequence of a statistically significant number of copies of several informative loci is determined. The counts of the different polymorphisms in the loci are used to calculate the percent contribution of the cfDNA from the sources within the mixed sample, with Aᵢ and Bᵢ representative of the counts of the A and B alleles for the ith locus. For example, for 20 informative loci sequenced, each one individually is referred to as the 1st, 2nd, 3rd, . . . , 20^{th}; thus A₅ and B₅ are the counts for the A and B alleles of the 5th locus.

The probability p of sequencing A alleles from these multiple measurements corresponds to a measure of enrichment of the DNA from the minor source. Each Aᵢ, Bᵢ pair of counts for the ith locus, however, has a different best estimate p, for the probability of sequencing an A allele. This is addressed by utilizing the product of many binomial distributions corresponding to informative loci that have been measured:

$${\prod }_{i} Binomial ( {A}_{i} , {B}_{i} , p ) .$$

The value of p that maximizes this product is denoted p*, and just as before gives the best estimate of enrichment of the minor source DNA when p=p*. The p* can be identified using any number of standard optimization algorithms, as described in more detail below. Frequently a logarithmic transformation is applied to the product to make the computations easier, while still producing the same result.

Using empirical data, an accurate estimation of fetal DNA frequency can be determined using the processes of the invention with a relatively tight confidence interval, regardless of the gender of the fetus. This approach differs from processes which utilize Y chromosome sequences derived from male fetuses for fetal frequency estimation (Fan et al., Proc Natl Acad Sci USA. 2008 Oct. 21; 105(42):16266-71. Epub 2008 Oct. 6; Lun F M et al., Proc Natl Acad Sci USA. 2008 Dec. 16; 105(50):19920-5. Epub 2008 Dec. 5). This approach also differs from other processes in that it employs a direct allelic identification approach rather than an indirect measure of either probe hybridization during real time PCR (Lun F M et al., Clin Chem. 2008 October; 54(10):1664-72. Epub 2008 Aug. 14) or band intensity following electrophoresis (Dhallan et al., Lancet. 2007 Feb. 10; 369(9560):474-81). Importantly, the invention utilizes multiple informative loci to determine fetal allele frequency, and the accuracy of the estimation can be improved by reducing the deviation of the different best estimate pᵢ* for each individual locus. Accuracy can also be increased by using additional loci in determination of p.

Detection of informative loci for use in the processes of the invention can be carried out using various techniques known to those skilled in the art. These include, but are not limited to, those described in U.S. Pat. No. 6,258,540, issued to Lo and Wainscoat; U.S. Pat. Nos. 7,901,884, 7,754,428, 7,718,367, 7,709,194, and 7,645,576 issued to Lo et al; U.S. Pat. No. 7,888,017 issued to Quake et al.; U.S. Pat. Nos. 7,727,720, 7,718,370, 7,442,506, 7,332,277, 7,208,274 and 6,977,162, issued to Dhallan; U.S. Pat. No. 7,799,531, issued to Mitchell and Mitchell; U.S. Pat. No. 7,582,420, issued to Oliphant et al.; U.S. Ser. No. 13/013,732 (Oliphant et al.); U.S. Ser. Nos. 13/205,490 and 13/205,570 (Sparks et al.); Chiu R W, et al. 2008 Proc Natl Acad Sci USA 105: 20458-20463; Dhallan et al. 2007 Lancet 369: 474-481; Fan H C et al., 2008 Proc Natl Acad Sci 105:16266-16271; Fan H C et al., 2010 Clin Chem 56:8; 1279-1286; Lo Y M et al., Proc Natl Acad Sci USA 104: 13116-13121; Lun F M, 2008 Clin Chem 54: 1664-1672; Lun F M et al., Proc Natl Acad Sci USA 105: 19920-19925; each of which are incorporated by reference herein.

In a preferred aspect, the distinguishing regions of the informative loci in the mixed sample are detected in a manner to maximize the counts detected for A and B values of each informative locus. This can be done, for example, by performing multiple identification reactions for the distinguishing regions at each locus. This reduces the bias in allele count that may be introduced from the experimental activities used to obtain the counts. The estimation of minor source DNA is thus more accurate with a tighter confidence interval.

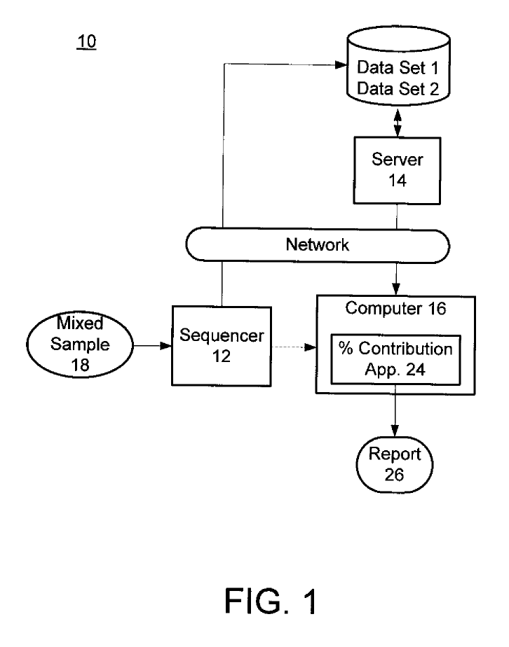

FIG. 1 is a block diagram illustrating an exemplary system environment in which one embodiment of the present invention may be implemented for determining contribution of cell free nucleic acids from the major source and/or minor source in a mixed sample. The system 10 includes a DNA sequencer 12, a server 14 and a computer 16. The DNA sequencer 12 may be coupled to the server 14 and/or the computer directly or through a network. The computer 16 may be in communication with the server 14 through the same or different network.

In one embodiment, a mixed sample 18 is input to the DNA sequencer 12. In one embodiment, the mixed sample 18 may comprise maternal and fetal cell free nucleic acids that contain cell free nucleic acids from normal cells and cancer cells. The DNA sequencer 12 may be any commercially available instrument that automates the DNA sequencing process, such as by analyzing light signals originating from fluorochromes attached to nucleotides in the mixed sample 18, for example. The output of the DNA sequencer 12 may be in the form of first and second data sets 20 comprising frequency data for one or more informed and loci from major and minor sources. In one embodiment, the first and second data sets 20 may be stored in a database 22 that is accessible by the server 14.

According to the exemplary embodiment, the computer 16 executes a software component, referred to herein as the percentage contribution application 24, that calculates an estimated contribution of cell free nucleic acids from at least one of the major source and minor source based on a binomial distribution of distinguishing regions from the first and second data sets of the mixed sample 18. In one embodiment, the computer 16 may comprise a personal computer, but the computer 24 may comprise any type of machine that includes at least one processor and memory.

The output of the percentage contribution application 24 is a report 26 listing the estimated contribution of cell free nucleic acids. The report 26 may be paper that is printed out, or electronic, which may be displayed on a monitor and/or communicated electronically to users via e-mail, FTP, text messaging, posted on a server, and the like.

Although the percentage contribution application 24 is shown as being implemented as software, the process may be implemented as a combination of hardware and software. In addition, the percentage contribution application 24 may be implemented as multiple components operating on the same or different computers.

Both the server 14 and the computer 16 may include hardware components of typical computing devices (not shown), including a processor, input devices (e.g., keyboard, pointing device, microphone for voice commands, buttons, touchscreen, etc.), and output devices (e.g., a display device, speakers, and the like). The server 14 and computer 16 may include computer-readable media, e.g., memory and storage devices (e.g., flash memory, hard drive, optical disk drive, magnetic disk drive, and the like) containing computer instructions that implement the functionality disclosed when executed by the processor. The server 14 and the computer 16 may further include wired or wireless network communication interfaces for communication.

Although the server 14 any computer 16 are shown as single computers, it should be understood that the that could be multiple servers and computers, and the functionality of the percentage contribution application 24 may be implemented using a different number of software components. For example, the percentage contribution application 24 may be implemented as more than one component.

Optimization Algorithms for Use with the Invention

The probability p* calculated by the percentage contribution application 24 that provides the best fit for p in the determination of the maximum likelihood estimate can be further refined using an optimization algorithm. Thus, in a preferred embodiment, the maximum likelihood estimate is calculated using an optimization algorithm to provide an iterative process for determining probability p that best fits the data of the two data sets. The optimization algorithm can be any algorithm that can determine the best fit for probability p based on the empirical informative loci data. Examples of such optimization algorithms include gradient descent, simulated annealing, or evolutionary algorithms. Simulated annealing (SA) is a generic probabilistic metaheuristic for the global optimization problem of locating a good approximation to the global optimum of a given function in a large search space. It is often used when the search space is discrete (e.g., all tours that visit a given set of cities). For certain problems, simulated annealing may be more effective than exhaustive enumeration—provided that the goal is merely to find an acceptably good solution in a fixed amount of time, rather than the best possible solution.

In other aspects, the algorithm is an evolutionary algorithm, which is a search heuristic that mimics the process of natural evolution. Evolutionary algorithms generate solutions to optimization problems using techniques inspired by natural evolution, such as inheritance, mutation, selection, and crossover.

In yet other aspects, the algorithm used is gradient descent, also known as steepest descent, or the process of steepest descent. Gradient descent is a first-order optimization algorithm. To find a local minimum of a function using gradient descent, one takes steps proportional to the negative of the gradient (or of the approximate gradient) of the function at the current point. If instead one takes steps proportional to the positive of the gradient, one approaches a local maximum of that function.

### EXAMPLES

The following examples are put forth so as to provide those of ordinary skill in the art with a complete disclosure and description of how to make and use the present invention, and are not intended to limit the scope of what the inventors regard as their invention, nor are they intended to represent or imply that the experiments below are all of or the only experiments performed. It will be appreciated by persons skilled in the art that numerous variations and/or modifications may be made to the invention as shown in the specific aspects without departing from the spirit or scope of the invention as broadly described. The present aspects are, therefore, to be considered in all respects as illustrative and not restrictive.

Efforts have been made to ensure accuracy with respect to numbers used (e.g., amounts, temperature, etc.) but some experimental errors and deviations should be accounted for.

### Example 1

### Calculation of Percent Contribution Using a Single Locus

In order to determine the percentage of cfDNA from a minor source within a mixed sample, the sequence of a statistically significant number of copies of an informative locus can be determined. The counts of the different polymorphisms in the loci are used to calculate the percent contribution of cfDNA from the major source and/or the minor source within the mixed sample.

In an informative locus with a single polymorphism, following sequence determination of the first allele (A) and the second allele (B), the number of alleles present in the sample are found empirically to be A=10 and B=100. The percent contribution (p) of the minor source allele, A, is determined using the following equation:

$$Binomial ( 10 , 100 , p ) = \frac{110 !}{10 ! 100 !} {{p}^{10} ( 1 - p )}^{100} .$$

For optimization, a maximum likelihood estimation (mle) function of the R statistical software system, version release 2.12.2, was used to perform all binomial calculations. Using the mle function in the R statistical software system, p* was estimated to be 0.09091285, which corresponds to a fetal enrichment of f=2*p=0.1818257.

### Example 2

### Calculation of Minor Source Percent Contribution Using Multiple Loci

In order to determine the percentage of cfDNA from a minor source within a mixed sample using multiple loci, the sequence of a statistically significant number of copies of two or more informative loci were determined. The counts of the different polymorphisms in the loci were used to calculate the percent contribution of cfDNA from the major source and/or the minor source within the mixed sample.

In a first example using multiple loci from a maternal sample comprising both maternal and fetal cfDNA, five informative loci with the following counts for the A and B alleles were determined empirically:

| I | Aᵢ | Bᵢ |
|---|---|---|
| 1 | 10 | 100 |
| 2 | 8 | 90 |
| 3 | 11 | 99 |
| 4 | 13 | 124 |
| 5 | 9 | 113 |

The process of the invention was then used to find the p^{*} that maximizes the product:

Binomial(10,100,p)*Binomial(8,90,p)*Binomial(11,99,p)*Binomial(13,124,p)*Binomial(9,113,p).

Using the mle function in the R statistical software system, version release 2.12.2, the p* was estimated to be 0.09695999, corresponding to a fetal enrichment estimate of f=2*p*=0.1939200.

### Example 3

### Calculation of Minor Source Percent Contribution Using Multiple Loci

The approach described in Example 2 was used to determine minor source contribution for over 200 distinct samples and 96 polymorphic loci from 12 different chromosomes, with the number of informative loci varying between 1 and 49. Exemplary samples and informative loci from different chromosomes are shown below in Tables 1-4. The informative loci counts were determined empirically, and the percent fetal cfDNA was calculated using the methods of the invention. These calculations were also compared to more standard ratio-based methods such as those described in Chu et al., Prenat Diagn 2010; 30: 1226-1229.

TABLE 1
Determination of Percent Fetal cfDNA for a
First Maternal Sample Using 49 Informative Loci
Sample 1

| | Aᵢ | Bᵢ | Binomial Percent | Chu et al., Percent |
|---|---|---|---|---|
| Loci | Counts | Counts | Fetal Calculation | Fetal Calculation |
| Ch01_Lc1 | 42 | 793 | 0.078836119 | 0.078820769 |
| Ch01_Lc2 | 34 | 744 | | |
| Ch01_Lc3 | 22 | 927 | | |
| Ch01_Lc4 | 28 | 552 | | |
| Ch01_Lc5 | 13 | 826 | | |
| Ch01_Lc6 | 37 | 753 | | |
| Ch01_Lc7 | 44 | 784 | | |
| Ch01_Lc8 | 18 | 482 | | |
| Ch02_Lc1 | 36 | 998 | | |
| Ch02_Lc2 | 52 | 1206 | | |
| Ch02_Lc3 | 45 | 844 | | |
| Ch03_Lc1 | 40 | 869 | | |
| Ch03_Lc2 | 20 | 516 | | |
| Ch03_Lc3 | 35 | 851 | | |
| Ch03_Lc4 | 21 | 785 | | |
| Ch03_Lc5 | 64 | 1020 | | |
| Ch03_Lc6 | 33 | 979 | | |
| Ch03_Lc7 | 30 | 1159 | | |
| Ch04_Lc1 | 28 | 499 | | |
| Ch04_Lc2 | 47 | 810 | | |
| Ch04_Lc3 | 18 | 587 | | |
| Ch05_Lc1 | 61 | 1191 | | |
| Ch05_Lc2 | 15 | 899 | | |
| Ch05_Lc3 | 21 | 566 | | |
| Ch05_Lc4 | 40 | 772 | | |
| Ch05_Lc5 | 36 | 1031 | | |
| Ch06_Lc1 | 41 | 822 | | |
| Ch06_Lc2 | 65 | 1078 | | |
| Ch07_Lc1 | 31 | 831 | | |
| Ch07_Lc2 | 39 | 857 | | |
| Ch07_Lc3 | 48 | 1148 | | |
| Ch07_Lc4 | 25 | 876 | | |
| Ch08_Lc1 | 39 | 869 | | |
| Ch08_Lc2 | 17 | 491 | | |
| Ch08_Lc3 | 31 | 585 | | |
| Ch08_Lc4 | 42 | 840 | | |
| Ch08_Lc5 | 47 | 963 | | |
| Ch09_Lc1 | 20 | 571 | | |
| Ch09_Lc2 | 25 | 692 | | |
| Ch09_Lc3 | 23 | 543 | | |
| Ch09_Lc4 | 32 | 742 | | |
| Ch09_Lc5 | 20 | 988 | | |
| Ch10_Lc1 | 28 | 555 | | |
| Ch10_Lc2 | 15 | 664 | | |
| Ch10_Lc3 | 11 | 814 | | |
| Ch11_Lc1 | 39 | 1036 | | |
| Ch11_Lc2 | 38 | 661 | | |
| Ch11_Lc3 | 34 | 779 | | |
| Ch12_Lc1 | 38 | 713 | | |
| Ch12_Lc2 | 35 | 973 | | |

TABLE 2
Determination of Percent Fetal cfDNA for a
Second Maternal Sample Using 35 informative Loci
Sample 2

| | Aᵢ | Bᵢ | Binomial Percent | Chu et al., Percent |
|---|---|---|---|---|
| Loci | Counts | Counts | Fetal Calculation | Fetal Calculation |
| Ch01_Lc1 | 34 | 946 | 0.064139309 | 0.0641358 |
| Ch01_Lc2 | 30 | 783 | | |
| Ch01_Lc3 | 37 | 795 | | |
| Ch02_Lc1 | 31 | 930 | | |
| Ch02_Lc2 | 25 | 571 | | |
| Ch02_Lc3 | 22 | 519 | | |
| Ch03_Lc1 | 29 | 768 | | |
| Ch03_Lc2 | 15 | 470 | | |
| Ch03_Lc3 | 17 | 583 | | |
| Ch03_Lc4 | 43 | 806 | | |
| Ch04_Lc1 | 27 | 988 | | |
| Ch04_Lc2 | 12 | 620 | | |
| Ch05_Lc1 | 43 | 1013 | | |
| Ch05_Lc2 | 16 | 671 | | |
| Ch05_Lc3 | 17 | 1112 | | |
| Ch06_Lc1 | 40 | 860 | | |
| Ch06_Lc2 | 27 | 948 | | |
| Ch06_Lc3 | 20 | 818 | | |
| Ch06_Lc4 | 22 | 538 | | |
| Ch07_Lc1 | 20 | 816 | | |
| Ch07_Lc2 | 18 | 1034 | | |
| Ch07_Lc3 | 37 | 1022 | | |
| Ch08_Lc1 | 40 | 685 | | |
| Ch08_Lc2 | 25 | 717 | | |
| Ch08_Lc3 | 7 | 633 | | |
| Ch08_Lc4 | 31 | 937 | | |
| Ch08_Lc5 | 20 | 767 | | |
| Ch09_Lc1 | 23 | 576 | | |
| Ch09_Lc2 | 15 | 682 | | |
| Ch10_Lc1 | 12 | 689 | | |
| Ch10_Lc2 | 27 | 788 | | |
| Ch11_Lc1 | 14 | 495 | | |
| Ch11_Lc2 | 21 | 686 | | |
| Ch12_Lc1 | 26 | 646 | | |
| Ch12_Lc2 | 42 | 810 | | |
| Ch12_Lc3 | 18 | 534 | | |

TABLE 3
Determination of Percent Fetal cfDNA for a
Third Maternal Sample Using 42 Informative Loci
Sample 3

| | Aᵢ | Bᵢ | Binomial Percent | Chu et al., Percent |
|---|---|---|---|---|
| Loci | Counts | Counts | Fetal Calculation | Fetal Calculation |
| Ch01_Lc1 | 36 | 1016 | 0.095311103 | 0.095301926 |
| Ch01_Lc2 | 34 | 567 | | |
| Ch01_Lc3 | 44 | 853 | | |
| Ch01_Lc4 | 19 | 910 | | |
| Ch01_Lc5 | 25 | 849 | | |
| Ch02_Lc1 | 33 | 1029 | | |
| Ch02_Lc2 | 33 | 953 | | |
| Ch02_Lc3 | 34 | 751 | | |
| Ch02_Lc4 | 27 | 722 | | |
| Ch02_Lc5 | 25 | 739 | | |
| Ch03_Lc1 | 31 | 1013 | | |
| Ch03_Lc2 | 30 | 833 | | |
| Ch04_Lc1 | 39 | 775 | | |
| Ch04_Lc2 | 33 | 528 | | |
| Ch04_Lc3 | 43 | 881 | | |
| Ch04_Lc4 | 51 | 1209 | | |
| Ch04_Lc5 | 32 | 931 | | |
| Ch04_Lc6 | 37 | 748 | | |
| Ch05_Lc1 | 39 | 828 | | |
| Ch05_Lc2 | 53 | 1151 | | |
| Ch05_Lc3 | 40 | 985 | | |
| Ch05_Lc4 | 26 | 582 | | |
| Ch05_Lc5 | 18 | 470 | | |
| Ch05_Lc6 | 43 | 954 | | |
| Ch05_Lc7 | 21 | 556 | | |
| Ch05_Lc8 | 24 | 724 | | |
| Ch06_Lc1 | 50 | 748 | | |
| Ch06_Lc2 | 41 | 1026 | | |
| Ch06_Lc3 | 56 | 1007 | | |
| Ch06_Lc4 | 53 | 901 | | |
| Ch07_Lc1 | 67 | 906 | | |
| Ch07_Lc2 | 28 | 959 | | |
| Ch08_Lc1 | 18 | 739 | | |
| Ch08_Lc2 | 63 | 1101 | | |
| Ch08_Lc3 | 35 | 739 | | |
| Ch09_Lc1 | 26 | 576 | | |
| Ch09_Lc2 | 39 | 956 | | |
| Ch11_Lc1 | 28 | 658 | | |
| Ch11_Lc2 | 38 | 771 | | |
| Ch12_Lc1 | 35 | 566 | | |
| Ch12_Lc2 | 32 | 697 | | |
| Ch12_Lc3 | 24 | 450 | | |

TABLE 4
Determination of Percent Fetal cfDNA for a
Third Maternal Sample Using 37 Informative Loci
Sample 3

| | Aᵢ | Bᵢ | Binomial Percent | Chu et al., Percent |
|---|---|---|---|---|
| Loci | Counts | Counts | Fetal Calculation | Fetal Calculation |
| Ch01_Lc1 | 24 | 959 | 0.034031329 | 0.034069811 |
| Ch01_Lc2 | 11 | 833 | | |
| Ch01_Lc3 | 18 | 836 | | |
| Ch02_Lc1 | 14 | 845 | | |
| Ch02_Lc2 | 17 | 612 | | |
| Ch02_Lc3 | 8 | 643 | | |
| Ch02_Lc4 | 10 | 583 | | |
| Ch03_Lc1 | 15 | 779 | | |
| Ch04_Lc1 | 14 | 970 | | |
| Ch04_Lc2 | 19 | 889 | | |
| Ch04_Lc3 | 11 | 799 | | |
| Ch05_Lc1 | 13 | 884 | | |
| Ch05_Lc2 | 11 | 938 | | |
| Ch05_Lc3 | 17 | 592 | | |
| Ch05_Lc4 | 14 | 894 | | |
| Ch06_Lc1 | 12 | 808 | | |
| Ch07_Lc1 | 12 | 900 | | |
| Ch07_Lc2 | 17 | 996 | | |
| Ch07_Lc3 | 14 | 813 | | |
| Ch07_Lc4 | 12 | 934 | | |
| Ch08_Lc1 | 12 | 672 | | |
| Ch08_Lc2 | 21 | 733 | | |
| Ch08_Lc3 | 14 | 809 | | |
| Ch08_Lc4 | 13 | 558 | | |
| Ch08_Lc5 | 8 | 669 | | |
| Ch08_Lc6 | 18 | 988 | | |
| Ch09_Lc1 | 14 | 744 | | |
| Ch09_Lc2 | 18 | 848 | | |
| Ch09_Lc3 | 13 | 705 | | |
| Ch09_Lc4 | 17 | 1073 | | |
| Ch09_Lc5 | 17 | 1091 | | |
| Ch10_Lc1 | 12 | 547 | | |
| Ch10_Lc2 | 9 | 824 | | |
| Ch10_Lc3 | 14 | 548 | | |
| Ch10_Lc4 | 15 | 958 | | |
| Ch11_Lc1 | 13 | 965 | | |
| Ch11_Lc2 | 11 | 641 | | |
| Ch12_Lc1 | 7 | 680 | | |

The algorithm used for optimization of the maximum likelihood estimate was the “Broyden, Fletcher, Goldfarb, and Shanno (BFGS)” method. The BFGS method is a gradient descent algorithm that approximates Newton's method. For optimization, the mle function of the R statistical software system, version release 2.12.2 was used to perform all binomial calculations

When compared to a weighted average approach introduced by Chu et al., the maximum likelihood estimate results from the binomial distribution approach presented above correlated with an R2>0.99 and a slope near 1.

A process and system for estimating the contribution of cell free nucleic acids from a major source and a minor source in a mixed sample has been disclosed herein. The present invention has been described in accordance with the implementations shown, and there could be variations to the implementations, and any variations would be within the spirit and scope of the present invention. For example, the exemplary embodiment can be implemented using hardware, software, a computer readable medium containing program instructions, or a combination thereof. Software written according to the present invention is to be either stored in some form of computer-readable medium such as a memory, a hard disk, or a CD/DVD-ROM and is to be executed by a processor. Accordingly, many modifications may be made by one of ordinary skill in the art without departing from the spirit and scope of the appended claims. In the claims that follow, unless the term “means” is used, none of the features or elements recited therein should be construed as means-plus-function limitations pursuant to 35 U.S.C. §112, ¶16.

What is claimed is:

1. A computer-implemented process for estimating a contribution of cell free nucleic acids from at least one of a major source and a minor source in a mixed sample, wherein at least one processor coupled to a memory executes a software component that performs the process, comprising:
accessing by the software component a first data set comprising frequency data for one or more informative loci from a major source;
accessing by the software component a second data set comprising frequency data for one or more informative loci from a minor source;
calculating by the software component an estimated contribution of cell free nucleic acids from the at least one of the major source and the minor source based on a binomial distribution of distinguishing regions from first and second data sets; and
outputting by the software component the estimated contribution of cell free nucleic acids from the at least one of the major source and the minor source.

2. The process of claim 1, wherein the mixed sample comprises cell free nucleic acids from both normal and putative genetically atypical cells.

3. The process of claim 1, wherein the mixed sample comprises cell free nucleic acids from two or more different organisms.

4. The process of claim 1, wherein the mixed sample comprises cell free nucleic acids from a donor cell source and a host recipient cell source.

5. The process of claim 1, wherein the software component quantifies the contribution by calculating the maximum likelihood estimate based on a quantity of the one or more informative loci from the major source and the minor source.

6. The process of claim 5, wherein the maximum likelihood estimate is modeled by the equation:
$$Binomial ( A , B , p ) = \frac{( A + B ) !}{A ! B !} {{p}^{A} ( 1 - p )}^{B}$$
wherein A is the quantity of an informative locus from the minor source, B is the quantity of an informative locus from the major source, and p is the maximum likelihood estimate for the binomial distribution with quantities A and B.

7. The process of claim 6, wherein the p corresponding to the maximum likelihood estimate is calculated using an optimization algorithm.

8. The process of claim 5, wherein frequency data for two or more informative loci from the major source and the minor source are used.

9. The process of claim 8, wherein the maximum likelihood estimate is modeled by the equation:
$${\prod }_{i} Binomial ( {A}_{i} , {B}_{i} , p ) .$$
wherein A is the quantity of the informative loci from the minor source, B is the quantity of informative loci from the major source, and p is the maximum likelihood estimate for the binomial distribution with quantities A and B.

10. The process of claim 9, wherein the p corresponding to the maximum likelihood estimate is calculated using an optimization algorithm.

11. A computer-implemented process for calculating a contribution of cell free nucleic acids from at least one of a minor source and major source in a mixed sample, wherein at least one processor coupled to a memory executes a software component that performs the process, comprising:
accessing by the software component a first data set comprising frequency data based on identification of distinguishing regions of one or more major source informative loci in the sample;
accessing by the software component a second data set comprising frequency data based on identification of distinguishing regions of one or more minor source informative loci in the sample;
calculating by the software component an estimated contribution of cell free nucleic acids from the at least one of the minor source and the major source based on a binomial distribution of the counts of distinguishing regions from first and second data sets; and
outputting by the software component the estimated contribution of cell free nucleic acids from the at least one of the major source and the minor source.

12. The process of claim 11, wherein the mixed sample comprises cell free nucleic acids from both normal and putative genetically atypical cells.

13. The process of claim 11, wherein the mixed sample comprises cell free nucleic acids from two or more different organisms.

14. The process of claim 11, wherein the mixed sample comprises cell free nucleic acids from a donor cell source and a host recipient cell source.

15. The process of claim 11, wherein the distinguishing regions comprise single nucleotide polymorphisms.

16. The process of claim 11, wherein the distinguishing regions comprise differences in methylation.

17. The process of claim 11, wherein the distinguishing regions comprise short tandem repeats.

18. The process of claim 11, wherein software component quantifies the contribution by calculating the maximum likelihood estimate based on the quantity of the informative loci from the major source and the minor source.

19. The process of claim 18, wherein the maximum likelihood estimate is modeled by the equation:
$$Binomial ( A , B , p ) = \frac{( A + B ) !}{A ! B !} {{p}^{A} ( 1 - p )}^{B}$$
wherein A is the quantity of an informative locus from the minor source, B is the quantity of an informative locus from the major source, and p is the maximum likelihood estimate for the binomial distribution with quantities A and B.

20. The process of claim 19, wherein the p corresponding to the maximum likelihood estimate is calculated using an optimization algorithm.

21. The process of claim 18, wherein frequency data for two or more informative loci from the major source and the minor source are used.

22. The process of claim 21, wherein the maximum likelihood estimate is modeled by the equation:
$${\prod }_{i} Binomial ( {A}_{i} , {B}_{i} , p ) .$$
wherein A is the quantity of the informative loci from the minor source, B is the quantity of informative loci from the major source, and p is the maximum likelihood estimate for the binomial distribution with quantities A and B.

23. The process of claim 22, wherein the p corresponding to the maximum likelihood estimate is calculated using an optimization algorithm.

24. A computer-implemented process for calculating a contribution of cell free nucleic acids from a maternal major source and a fetal minor source in a maternal sample, wherein at least one processor coupled to a memory executes a software component that performs the process, comprising:
accessing by the software component a first data set comprising frequency data based on identification of distinguishing regions from copies of one or more informative loci from the maternal major source;
accessing by the software component a second data set comprising frequency data based on identification of distinguishing regions from copies of one or more informative loci from the fetal minor source;
calculating by the software component an estimated contribution of cell free nucleic acids from the at least one of the maternal source and the fetal source based on a binomial distribution of the counts of the distinguishing regions from first and second data sets; and
outputting by the software component the estimated contribution of cell free nucleic acids from the at least one of the maternal major source and a fetal minor source.

25. The process of claim 24, wherein the distinguishing regions comprise single nucleotide polymorphisms.

26. The process of claim 24, wherein the distinguishing regions comprise differences in methylation.

27. The process of claim 24, wherein the distinguishing regions comprise short tandem repeats.

28. The process of claim 24, wherein the software component quantifies the contribution by calculating the maximum likelihood estimate based on the quantity of the informative loci from the major source and the minor source.

29. The process of claim 28, wherein the contribution is modeled by the equation:
$$Binomial ( A , B , p ) = \frac{( A + B ) !}{A ! B !} {{p}^{A} ( 1 - p )}^{B} .$$
wherein A is the count of informative loci from the minor source, B is the is the count of informative loci from the major source, and p is the maximum likelihood estimate for the binomial distribution with quantities A and B.

30. The process of claim 29, wherein the p corresponding to the maximum likelihood estimate is calculated using an optimization algorithms.

31. The process of claim 28 wherein frequency data for two or more informative loci from the major source and the minor source are used.

32. The process of claim 28, wherein the maximum likelihood estimate is modeled by the equation:
$${\prod }_{i} Binomial ( {A}_{i} , {B}_{i} , p ) .$$
wherein A is the quantity of the informative loci from the minor source, B is the quantity of informative loci from the major source, and p is the maximum likelihood estimate for the binomial distribution with quantities A and B.

33. The process of claim 32, wherein the p corresponding to the maximum likelihood estimate is calculated using an optimization algorithm.

34. An executable software product stored on a computer-readable medium containing program instructions for estimating nucleic acid contribution in a mixed sample, the program instructions for:
inputting a first data set comprising frequency data based on identification of distinguishing regions from copies of one or more informative loci from a major source;
inputting a second data set frequency data based on identification of distinguishing regions from copies of one or more informative loci from a minor source; and
calculating a percent contribution of cell free nucleic acids from at least one of the major source and the minor source based on a binomial distribution of the first and second data sets.

35. A system, comprising:
a memory;
a processor coupled to the memory; and
a software component executed by the processor that is configured to:
receive a first data set comprising the frequency data based on identification of distinguishing regions from copies of one or more informative loci from a major source;
receive a second data set comprising the frequency data based on identification of distinguishing regions from copies of one or more informative loci from a minor source; and
calculate a percent contribution of cell free nucleic acids from at least one of the major source and the minor source based on a binomial distribution of the first and second data sets.

36. A computer software product including a non-transitory computer-readable storage medium having fixed therein a sequence of instructions which when executed by a computer direct performance of steps of:
creating a first data set representing a quantity of informative loci from a minor source in a mixed sample;
creating a second data set representing a quantity of informative loci from a major source in the mixed sample; and
calculating a percent contribution of cell free nucleic acids from at least one of the major source and the minor source based on a binomial distribution of distinguishing regions from first and second data sets.
